(19) United States
(12) Patent Application Publication
(10) Pub. No.: US 2026/0202170 A1
(43) Pub. Date: Jul. 16, 2026

(54) SIGHTING OR VIEWING TELESCOPE

(71) Applicant: THALES, MEUDON (FR)

(72) Inventors: Frédéric DIAZ, SAINT-HEAND (FR); Bruno COUMERT, SAINT-HEAND (FR)

(21) Appl. No.: 19/135,356

(22) PCT Filed: Dec. 19, 2023
(86) PCT No.: PCT/EP2023/086633

§ 371 Date: Jun. 3, 2025

(30) Foreign Application Priority Data
Dec. 22, 2022 (FR) FR2214200

(51) Int. Cl. F41G 1/30; F41G 3/16; G02B 23/04; G02B 23/10; G02B 27/01

(52) U.S. Cl. CPC F41G 1/30; F41G 3/165; G02B 23/04; G02B 23/10; G02B 27/0101

(57) ABSTRACT

A sighting or observation scope having a sighting or observation axis x includes in a mechanical structure: a camera, a first video micro-display displaying an image of the external landscape acquired by the camera, referred to as first object an eyepiece associated with the first video micro-display and forming a first image of the first object at infinity a second video micro-display displaying a second object an optical combining device arranged optically downstream of the eyepiece and designed to form an image at infinity of the second object, referred to as second image, and to superimpose the first and second image on the external landscape.

### CROSS-REFERENCE TO RELATED APPLICATIONS

This application is a National Stage of International patent application PCT/EP 2023/086633, filed on Dec. 19, 2023, which claims priority to foreign French patent application No. FR 2214200, filed on Dec. 22, 2022, the disclosures of which are incorporated by reference in their entireties.

### FIELD OF THE INVENTION

The field of the invention is that of aiming scopes, in particular reflex viewfinders, which make it possible to superimpose a reticle on the observed scene.

### BACKGROUND

To carry out their various missions with their weaponry, an infantryman has the following needs:
Daytime and nighttime shooting capability, requiring precise sighting to make best use of their weapon, ideally for effective shooting beyond 300 meters;
Rapid sighting in dynamic combat situations;
Maintaining good situational awareness so as to deal with any threat that may arise on the battlefield, both during the day and at night. This situational awareness notably involves maintaining a wide field of vision covering the surrounding space;
Ability to “decamouflage” or perceive threats, both during the day and at night;
Discretion, which comprises, notably at night, the absence of light emission from the sighting members;
Absence of any boresighting setting operation to switch from daytime sighting to nighttime sighting and vice versa, so as to save time and ensure the reliability of the sighting;
Mobility and endurance, this requiring a piece of equipment that is as lightweight and compact as possible.

These needs are reflected in strong demands placed on the sighting members fitted on the assault rifle provided to the infantryman. In practice, these demands are only partially met, and are not met with a single piece of equipment that is both compact and lightweight.

Current solutions for carrying out sighting on an assault rifle are as follows. For daytime sighting, the weapon comprises a basic eyecup-handlebar assembly. This assembly is simple, robust and inexpensive, but offers little precision.

The weapon may also comprise, for daytime sighting, an illuminated sight (or “reflex”), that is to say an optical assembly for superimposing a symbol or a light spot in the sighting axis onto the outside world. This illuminated sight may optionally be associated with switchable magnifying optics. It may furthermore comprise a laser pointer and a magnifying daytime scope.

For nighttime sighting, the weapon may comprise: a laser pointer, a light-intensifying aiming scope referred to as “IL”, an infrared aiming scope referred to as “IR”, a light-intensifying or infrared adaptor or clip-on positioned upstream of a daytime aiming scope, a sighting device comprising night vision binoculars associated with an illuminated sight integral with the weapon.

These known solutions each have advantages and drawbacks, but none of them completely addresses the overall need identified above.

The illuminated sight solution is particularly appreciated because it offers good precision, while at the same time maintaining good perception of the overall situation, the illuminated sight transmitting the landscape without magnification.

Sighting by way of a laser pointer, which is widely used, notably at night, is highly beneficial because it allows rapid firing in dynamic combat, without the need to align the eye behind a sight, or even to support the weapon in extreme situations. On the other hand, the laser pointer remains indiscreet, notably at night. Even when it is a pointer emitting in the near infrared, it is easy to detect with night vision binoculars or even with some equipment using a camera sensitive in the near infrared.

Aiming scopes in general, be these daytime scopes or nighttime scopes, light-intensifying scopes or thermal infrared scopes, have the advantage of their precision, by virtue notably of their magnification. They have the drawback of having to position the eye used for sighting close to an eyepiece; moreover, the user is not able to use the other eye for overall perception. This operation takes a certain amount of time, which constitutes a loss of effectiveness in dynamic combat. In addition, the shooter momentarily cuts off from their environment and may then ignore new threats. Finally, at night, if they are equipped with night vision binoculars, the fighter has to move them out of the way to be able to correctly position a free eye behind the aiming scope. Again, this represents an additional delay in the action and a break from the environment of the fighter.

Infrared or thermal aiming scopes have the same drawbacks but offer a few significant advantages: night vision, including in total darkness, improved vision in mist and smoke of the battlefield and, above all, the ability to “decamouflage” any hot target.

In an attempt to provide an appropriate response, it is possible to juxtapose multiple systems in a single piece of equipment. For example, as may be seen in FIG. 1, some pieces of sighting equipment group together an IL or IR aiming scope topped by an illuminated sight. In this case, the scope comprises a thermal camera and a visualization device. The thermal camera comprises a focusing objective 1 and a photosensitive receiver 2. The visualization device comprises a micro-display 3 and an eyepiece 4. The illuminated sight comprises a luminous symbol 5 and collimation optics 6 and superposition optics (typically a splitter plate) for superposition with the direct view 7.

These solutions result in relatively bulky pieces of equipment that offer juxtaposition of functions without, however, combining them. At a given time, the user has to choose to use either the illuminated sight or the scope and therefore never benefits from the combined advantages of the two systems. In the case of a system combining a thermal infrared scope and an illuminated sight, the user must choose between benefiting from the rapid sighting and situational awareness offered by the illuminated sight or benefiting from the decamouflaging and night vision offered by the thermal scope.

An improved solution is illustrated in FIG. 2. The same references as those in FIG. 1 designate the same elements as those described in FIG. 1. The architecture of FIG. 2 consists in combining an “advanced” reflex viewfinder architecture with a single display 3 that is responsible for displaying everything: video stream, symbology, reticle, etc. The image of the display is returned at infinity using an eyepiece 3. Fusion with the scene is achieved using a semi-reflective plate 7.

The reflex viewfinder with a display of FIG. 2, coupled with a light-intensifying or infrared camera 2, thus exhibits real added value because it provides additional assistance for highlighting a target in difficult conditions (target camouflaged, darkness, etc.) by compactly combining night and day vision.

The solution of FIG. 2, although it constitutes a significant improvement over the architecture of FIG. 1, has a drawback, however. If the display 3 malfunctions, all video, symbology and reticle functions of the viewfinder are lost. In addition, the display necessarily has a high display rate in order to carry out all of the abovementioned functions (typically 20 Hz or more). This means significant power consumption for the display, resulting in autonomy of the sight of FIG. 2 that is limited to a few hours. Once the battery cells have been used up, or the battery is empty, this reflex viewfinder no longer works, even for basic functions such as displaying a reticle.

In summary, existing solutions based on a single illuminated-sight, pointer or scope principle do not address all of the needs of the infantryman for shooting in any situation.

### SUMMARY OF THE INVENTION

The invention aims to overcome some of the abovementioned problems of the prior art. To this end, one subject of the invention is a sighting or observation scope comprising notably a camera, a first video micro-display displaying an image of the external landscape acquired by the camera and a second video micro-display. The use of two displays makes it possible to make the viewfinder of the invention more versatile and robust. In addition, by selecting one micro-display with low power consumption compared to the other micro-display, the scope of the invention allows operation in a “degraded” mode by displaying a red dot/customizable reticle with an autonomy of a few hundred hours. The user is thus able to extend their mission when the capacity of the battery supplying power to the viewfinder drops below a critical threshold.

To this end, one subject of the invention is a sighting or observation scope having a sighting or observation axis x and comprising, in a mechanical structure:
a camera,
a first video micro-display displaying an image of the external landscape acquired by the camera, referred to as first object
an eyepiece associated with the first video micro-display and forming a first image of the first object at infinity
a second video micro-display displaying a second object
an optical combining device arranged optically downstream of the eyepiece and designed to form an image at infinity of the second object, referred to as second image, and to superimpose the first and second image on the external landscape.

According to one embodiment, the second micro-display is a micro-display with low power consumption compared to the first micro-display.

Preferably, in this embodiment, the second micro-display has a refresh rate less than or equal to 2 Hz, the first micro-display having a refresh rate greater than or equal to 20 Hz.

Preferably, in this embodiment, the scope comprises a battery supplying power to the camera, the first and second video micro-display and a processor, said processor being configured to make the battery operate in two distinct modes comprising:
in a first mode, supplying power to the first video micro-display and not supplying power to the second video micro-display or supplying power to the first and second micro-display when a capacity of the battery is greater than a predetermined limit or when the user chooses it, for example by pressing a control member offset on said mechanical structure,
in a second mode, supplying power to the second video micro-display and not supplying power to the first video micro-display when a capacity of the battery is less than the predetermined limit, or when the processor detects malfunctioning of the first display, or when the user chooses it, for example by pressing a control member offset on said mechanical structure.

Even more preferably, the predetermined limit corresponds to an autonomy of the battery in the first operating mode of less than 1 hour of use.

According to one embodiment, the first micro-display emits radiation in a first spectral range and the second micro-display emits radiation in a second spectral range disjoint from the first spectral range or the first and second micro-displays emit radiation in one and the same spectral range but having cross-polarization.

According to one embodiment, the optical combining device comprises:
a plane semi-reflective surface inclined by approximately 45 degrees to the sighting or observation axis x or a surface comprising a dichroic treatment designed to reflect a spectral range of the radiation emitted by the first micro-display, said plane semi-reflective surface being designed to perform said superposition of the first and second image on the external landscape
a holographic or diffractive element or a metasurface arranged on the optical path of the rays coming from the second display and designed to form said second image.

Preferably, the holographic or diffractive element or said metasurface has a holographic treatment and/or a structure specifically designed to form an image from rays having a wavelength in the second spectral range and designed to transmit the first spectral range.

Preferably, the holographic or diffractive element or said metasurface is deposited on or added to the plane semi-reflective surface. As an alternative, the holographic or diffractive element or said metasurface is separate from the plane semi-reflective surface.

According to one embodiment, the optical combining device comprises:
a plane semi-reflective surface inclined by approximately 45 degrees to the sighting or observation axis x, said plane semi-reflective surface being designed to perform said superposition of the first and second image on the external landscape
a freeform or aspherical concave surface inclined with respect to the sighting or observation axis x and arranged on the optical path of the rays coming from the second display so as to form said second image.

According to one embodiment, the optical combining device comprises:
a plane semi-reflective surface inclined by approximately 45 degrees to the sighting or observation axis x, said plane semi-reflective surface being designed to perform said superposition of the first and second image on the external landscape
an additional eyepiece designed to form the second image,
a pupil-expansion light guide arranged on the optical path of the rays coming from the second display and designed to extend a pupil of the additional eyepiece in two directions of space by also participating in said superposition of the first and second image on the external landscape.

### BRIEF DESCRIPTION OF THE DRAWINGS

Other features, details and advantages of the invention will become apparent on reading the description given with reference to the appended drawings, which are given by way of example and in which, respectively:

FIG. 1 shows a schematic view of a sighting scope from the prior art,

FIG. 2 shows a schematic view of a sighting scope from the prior art,

FIG. 3A shows a perspective view of a sighting or observation scope according to the invention,

FIG. 3B shows a schematic view of a sighting or observation scope according to the invention,

FIG. 3C shows a perspective view of a sighting or observation scope according to one preferred embodiment of embodiment M1 of the invention,

FIG. 4 shows a schematic depiction of one embodiment of the scope of the invention,

FIG. 5 shows a schematic depiction of one embodiment of the scope of the invention,

FIG. 6 shows a schematic depiction of one embodiment of the scope of the invention.

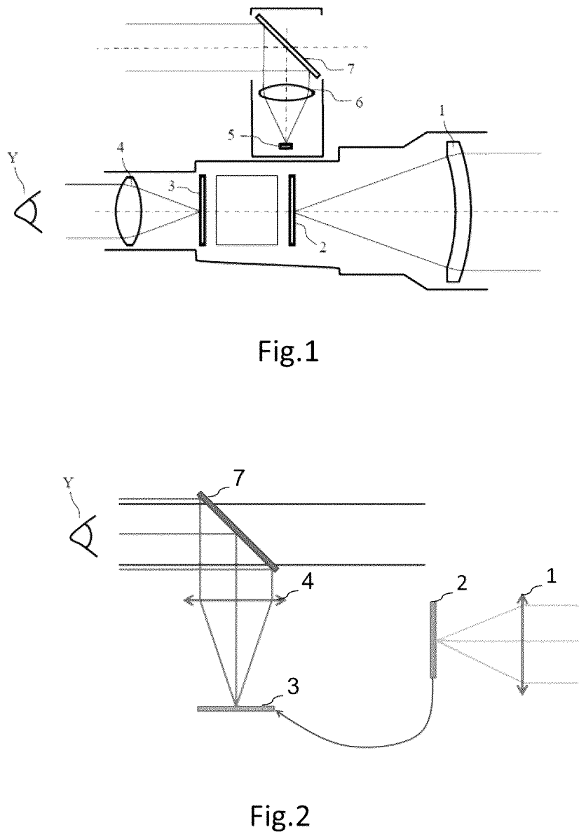

In the figures, unless indicated otherwise, the elements are not to scale and identical references designate identical elements.

### DETAILED DESCRIPTION

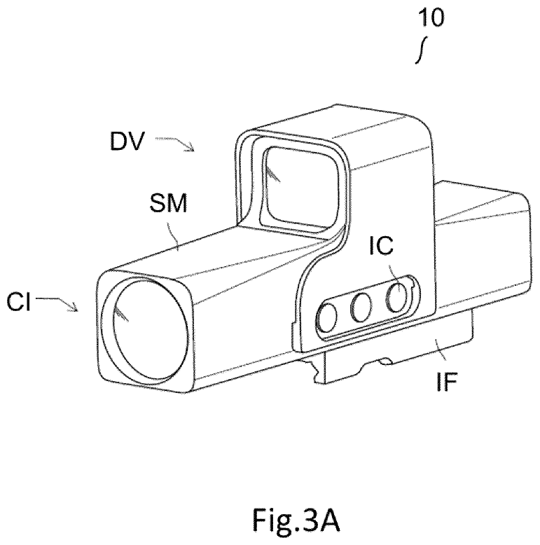

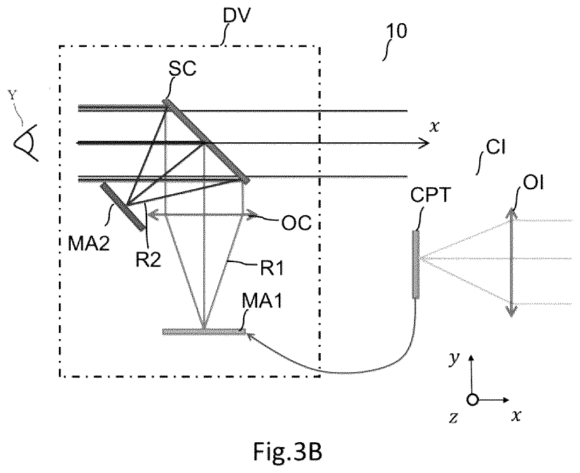

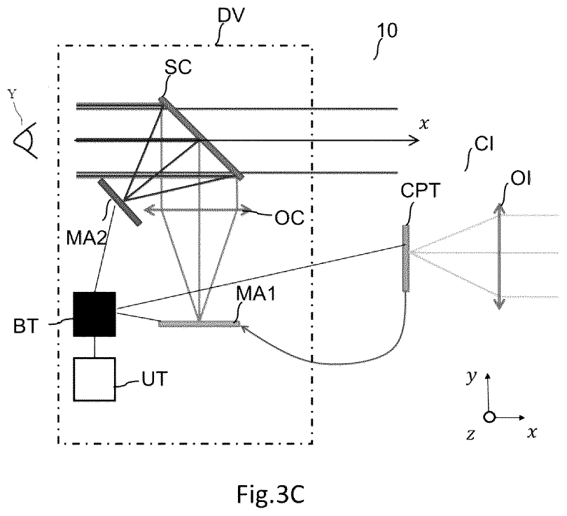

FIG. 3A shows a perspective view of a sighting or observation scope 10 according to the invention. FIG. 3B is a schematic depiction of the elements contained in the mechanical structure SM of the sighting or observation scope 1 according to the invention having a sighting or observation axis x. The scope 10 essentially comprises two main subassemblies, which are a camera CI and a visualization device DV, the structure of which is described in more detail in FIG. 3B.

The visualization device DV comprises a first and a second micro-display MA1, MA2, an eyepiece OC associated with the first display MA1 and an optical combining device SC. By way of example, as illustrated in FIG. 3A, the optical combining device SC is mounted above the camera CI. As an alternative, the camera is above or to the side of the optical combining device SC. The assembly of optical and electronic components is integrated into the waterproof mechanical structure SM, which protects them from the external environment and from impacts.

This structure SM comprises a mechanical fixing interface IF for fixing it to a weapon equipped with a standard interface. This interface is for example a “Picatinny” rail or its equivalent.

The structure also comprises an assembly IC of buttons and control members for carrying out notably the on/off commands for the various functions of the item of equipment, the brightness settings of the video micro-displays MA1, MA2, the electronic and mechanical boresighting settings, and the electronic settings for superimposing the various images that are generated on the external landscape. It may be positioned on one of the two lateral flanks of the scope. By way of non-limiting example, in FIG. 3A, the assembly comprises three buttons positioned on the left-hand lateral flank of the scope, other buttons being positioned on the right-hand flank of the scope.

According to one embodiment of the invention, the camera CI is a thermal camera, comprising an infrared objective Ol operating in the spectral band situated between 8 μm and 12 μm and an infrared sensor CPT sensitive in the same spectral band or between 3 and 5 μm.

As an alternative, according to another embodiment, the camera is a low-light-level camera implementing a low-noise CMOS sensor CPT, CMOS standing for Complementary Metal Oxide Semiconductor, or an EB-CMOS sensor, EB-CMOS standing for Electro-Bombarded CMOS, or else any other digital low-light-level camera.

The camera may also be an SWIR camera, SWIR standing for Short Wave Infrared, operating in the spectral band between 1 μm and 2 μm, capturing night light resulting from night glow and also offering decamouflage capabilities.

The camera CI comprises power supply, sensor control and image processing electronics and also a power supply module (none of these being shown) receiving multiple battery cells or a rechargeable battery pack so as to provide autonomy therefor, this being positioned for example at the rear of the scope, on the side of the observer's eye.

The visualization device DV comprises the first video micro-display MA1, the eyepiece OC forming an image of the first video micro-display at infinity and the electronics needed to supply power to and control the first micro-display.

The first micro-display MA1 displays a sighting video reticle, possibly enriched with elevation correction elements or symbols or stadiametric graduations. It also displays an image of the external landscape acquired by the camera, referred to as first object. R1 denotes the radiation emitted by the first micro-display MA1. According to one embodiment, the first micro-display MA1 displays only the image of the external landscape acquired by the camera.

The visualization device DV furthermore comprises the second video micro-display MA2 and the optical combining device SC. The image displayed by the second video micro-display MA2 is called “second object”, and R2 denotes the radiation emitted by the second micro-display MA2.

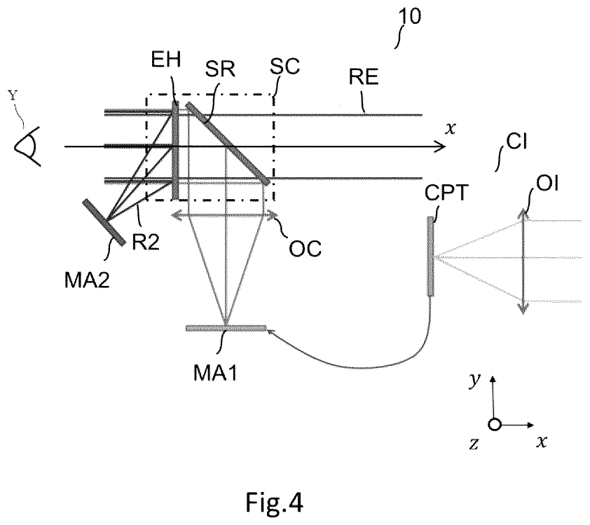

The optical combining device SC is arranged optically downstream of the eyepiece OC and is designed to form an image at infinity of the second object, referred to as second image, and to superimpose the first and second image on the external landscape. Various examples of optical combining devices SC are described below (see FIGS. 4 to 6).

The first and second video micro-display MA1, MA2 are, by way of example, OLED displays, OLED standing for Organic Light Emitting Diode, LCD displays, LCD standing for Liquid Crystal Display, or LCOS displays, LCOS standing for Liquid Crystal On Silicon.

The use of two displays makes it possible to make the scope of the invention more versatile by combining multiple functions (for example, one display relaying an IR image in a spectral band between 1 and 2 μm and another relaying a thermal image (in a spectral band between 2 and 15 μm)). In addition, this makes the scope of the invention more robust, for example by allowing switching to the second micro-display when the first micro-display malfunctions.

In addition, by selecting one micro-display with low power consumption compared to the other micro-display, the scope of the invention allows operation in a “degraded” mode by displaying a red dot/customizable reticle with an autonomy of a few hundred hours. The user is thus able to extend their mission when the capacity of the battery supplying power to the viewfinder drops below a critical threshold.

More precisely, according to a first embodiment M1, the second micro-display is a micro-display with low power consumption compared to the first micro-display. “Low power consumption” is understood here to mean that the second micro-display has a power consumption of between 0.5 mW and 10 mW, whereas the first micro-display has a power consumption of greater than or equal to 50 mW.

Preferably, in embodiment M1, the second micro-display displays a red dot or a luminous symbol. Since the luminous object is fixed over time, the power consumption of the second micro-display is greatly reduced.

Preferably, in embodiment M1, the second micro-display has a refresh rate less than or equal to 2 Hz in order to reduce its power consumption. In addition, the refresh rate of the first micro-display is high in order to be compatible with a video stream. Therefore, the first micro-display has a refresh rate greater than or equal to 20 Hz.

By way of non-limiting example, in embodiment M1, the first video micro-display MA1 is an MDP07 OLED from Microoled. It allows the reflex viewfinder to operate nominally by projecting any available information: reticle, symbology, image, video stream, etc.

By way of non-limiting example, in embodiment M1, the second video micro-display MA2 is an MDP05 OLED from Microoled.

According to one variant (denoted V1) of the first embodiment, the first micro-display MA1 displays only the image of the external landscape acquired by the camera, whereas the second micro-display MA2 displays a sighting reticle.

FIG. 3C illustrates one preferred embodiment of embodiment M1, in which the scope 10 comprises a battery BT supplying power to the camera CI, the first and second video micro-display MA1, MA2 and a processor UT controlling the operation of the battery in a first and second mode.

In the first mode, the battery supplies power to the first video micro-display and does not supply power to the second video micro-display when a capacity of the battery is greater than a predetermined limit. As an alternative, according to variant V1, the battery supplies power to the two micro-displays MA1, MA2 in the first operating mode.

In the second mode, the battery supplies power to the second video micro-display and does not supply power to the first video micro-display when a capacity of the battery is less than the predetermined limit. The processor UT thus enables the battery to operate in a second “degraded” mode in order to save the autonomy of the scope 10 when the capacity of the battery falls below a limit defined by the user or the manufacturer. In this degraded mode, only a simple reticle is then able to be used by the user. As an alternative, the reticle is displayed in combination with at least one element displaying information on the viewfinder, for example a low battery indicator and/or elements for carrying out various settings such as electronic boresighting setting, brightness adjustment, etc.

Preferably, the predetermined limit of the battery corresponds to an autonomy of the battery in the first operating mode of less than 1 hour of use. By way of non-limiting example, this limit is equal to 1000 mAh±50%. This limit makes it possible to continue to obtain the display of a red dot with an autonomy of a few hundred hours via the switch to the second operating mode of the battery.

In a first variant of the embodiment of FIG. 3C, the processor is furthermore configured such that the battery operates in the second mode (supplying power to the second video micro-display and not to the first video micro-display) when the processor detects malfunctioning of the first display or of the camera CI. By way of example, the malfunction may be a power supply problem. This variant makes it possible to obtain a more robust scope 10.

In a second variant of the embodiment of FIG. 3C, which may be combined with the first variant, the processor is furthermore configured such that the battery operates in the second mode or in the first mode depending on the selection made by the user, for example by pressing one of the control members IC offset on the mechanical structure SM. This variant makes it possible to obtain a more versatile scope by selecting an enriched mode (first mode) or degraded mode (second mode) depending on the mission and the evolution thereof.

According to the embodiment illustrated in FIGS. 3B and 3C, the scope of the invention is a reflex viewfinder and the optical chain consisting of the camera, the first micro-display and the eyepiece has a unit magnification, the image of the first micro-display being in conformity with that of the external landscape. The optical combining device SC then ensures perfect superposition of the image of the micro-display on the landscape.

As an alternative, according to another embodiment, the scope has a magnification greater than one. For this purpose, the scope 1 comprises for example an afocal optical system arranged optically downstream of the optical combining device SC so as to form a superimposed image of the first and second micro-display and of the observed scene with a magnification greater than 1.

As explained above, the optical combining device SC is an optical element that carries out a collimation function for the beam coming from the second micro-display and a superposition function by superimposing the image of the first micro-display and the image of the second micro-display on the external landscape.

In order to facilitate the design and manufacture of the optical combining device SC, the first micro-display emits radiation R1 in a first spectral range and the second micro-display emits radiation R2 in a second spectral range disjoint from the first spectral range. This also makes it possible to guarantee optimum transmission of the flux coming from the observed scene and of the flux coming from the first micro-display.

In order to further simplify the design of the device SC, advantageously, the first and second spectral range have a spectral extent less than or equal to 20 nm, achieved for example by adding spectral filters positioned in front of the micro-displays.

As an alternative, in order to facilitate the design and manufacture of the optical combining device SC, the two micro-displays emit radiation R1, R2 respectively in one and the same spectral range but having cross-polarization.

FIG. 4 is a schematic depiction of one embodiment of the scope 10 in which the optical combining device SC is a holographic or diffractive element EH, or else a metasurface.

The optical combining device SC comprises a plane semi-reflective surface SR or a surface SR comprising a dichroic treatment designed to reflect the spectral range of the radiation R1, which is inclined by approximately 45 degrees to the sighting or observation axis x. “Approximately 45 degrees” is understood to mean 45 degrees±5 degrees. The plane semi-reflective surface (or the surface with a dichroic treatment) SR is designed to superimpose the image of the first micro-display (the first image) and the image of the second micro-display (the second image) on the external landscape.

Typically, the semi-reflective surface is integrated into a splitter plate comprising two plane and parallel faces. As an alternative, the semi-reflective surface is integrated into a splitter cube comprising two plane and parallel faces, or else a prism.

The holographic or diffractive element or the metasurface EH is arranged on the optical path of the rays R2 coming from the second display. By virtue of its structure, the holographic or diffractive element or the metasurface EH is suitable for forming the image of the second micro-display at infinity.

Holographic optical elements are optical components obtained by recording a two-wave interference phenomenon in a photosensitive material, the interference causing optical index variations within the material that are preserved when the hologram is subsequently developed. These elements are said to be thick phase holograms in that the photosensitive material has to have a certain thickness so as to allow a significant number of interference fringes to be recorded, and also in that index variations cause only phase variations on the incident light waves, without any amplitude variation. These elements may work based on reflection or transmission. These holographic elements have a certain number of noteworthy properties. Indeed, it is possible to obtain a wide variety of optical functions by varying the shape of the recording waves. These functions are, in part, independent of the shape of the medium for the holographic optical element. A holographic optical element recorded on a plane medium may thus possess optical power and have a function comparable to that of a prism, of a lens or of a mirror.

In the embodiment of FIG. 4, if the element EH is a holographic component, the holographic processing is thus designed to have an optical power in order to be able to perform the function of collimating the rays R2 coming from the second display.

Finally, these holographic elements exhibit, by nature, spectral selectivity. For a given incidence, the holographic component reflects light in a given spectral band and is transparent outside this spectral band, the spectral band depending on the recording wavelength and, more generally, on the recording conditions (see notably the article “Coupled Wave Theory for thick Hologram Gratings”, The Bell System Technical Journal, Vol. 48, November1969, no. 9 for all information on the diffractive operation of this type of hologram).

For this reason, when the element EH is a holographic component in the embodiment of FIG. 4, the first micro-display emits radiation in a first spectral range and the second micro-display emits radiation in a second spectral range disjoint from the first spectral range, the first and second spectral range having a spectral extent less than or equal to 20 nm. The holographic element EH thus has a holographic treatment and/or a structure designed specifically to form an image at infinity of rays having a wavelength in the second spectral range and designed to transmit the first spectral range.

In the embodiment in which the element EH is a diffractive component or a metasurface, this spectral selectivity may also result from an angle of incidence of the rays coming from the first display with respect to the element EHD.

As an alternative, according to another embodiment, in order to perform the superposition in an appropriate manner when the element EH is a diffractive component or a metasurface, the two micro-displays MA1, MA2 emit radiation R1, R2 in one and the same spectral range but having cross-polarization. In this embodiment, one or more polarized screens are arranged on the optical path of the radiation R1 so that the element EH forms an image at infinity of the rays having the polarization associated with the micro-display MA2 and to transmit the rays having the polarization associated with the micro-display MA1.

According to the embodiment illustrated in FIG. 4, the holographic or diffractive element or the metasurface EH is arranged so as to be separate from the plane semi-reflective surface SR. This embodiment makes it possible to facilitate the design and manufacture of the elements EH and SR. Indeed, it is then possible to design an element EH such that it has an optical power for the rays R2 for carrying out the collimation function, without it additionally carrying out a superposition function for the first image and the second image on the external landscape. Preferably, in this embodiment, the holographic or diffractive element or the metasurface EH is arranged so as to be substantially perpendicular to the sighting or observation axis x. This makes it possible to maximize the compactness of the scope of the invention. In addition, depending on the structure of the element EH, this potentially makes it possible to maximize the transmission of rays RE coming from the external landscape. “Substantially perpendicular” is understood here to mean that the element EH is perpendicular to the sighting or observation axis x ±10°.

By way of non-limiting example, in the embodiment in which the element EH is a metasurface or a diffractive element, the element EH is machined for example by a diamond tip, by laser ablation, by lithography, by engraving, by molding or else by pressing.

In the embodiment in which the element EH is a diffractive element, the latter may comprise two or more relief levels (also called levels).

In the embodiment in which the element EH is a metasurface, the latter is created by modulating the density of the reliefs, which are substantially all of the same height, with respect to a planar substrate.

By way of non-limiting example, in the embodiment in which the element EH is a holographic element, the latter may be a thick volume hologram obtained by interference of two coherent light beams producing a variation in refractive index in a layer of photosensitive material. As an alternative, the element EH is a thin volume hologram in which the index variation is perpendicular to the substrate, or a surface hologram, or a CGH hologram (for computer generated hologram) produced using the same process as a diffractive element EH of the invention.

As an alternative, according to one embodiment different from the one illustrated in FIG. 4, the holographic or diffractive element or the metasurface EH is deposited on or added to the plane semi-reflective surface SR. This embodiment exhibits better compactness than the one of FIG. 4. However, it has the disadvantage of being more complex to design and manufacture, because a single element has to carry out a collimation function for the rays R2 and a superposition function for the first image and the second image on the external landscape. By way of non-limiting example, in this embodiment, the element EH makes it possible to collimate the radiation R1 emitted by the micro-display MA1 and to collimate the radiation R2 emitted by the micro-display MA2. Separation of the functions of collimating the radiation R1 and of collimating R2 is made possible via two distinct variants:
the two micro-displays MA1, MA2 emit radiation in one and the same spectral range but having cross-polarization, the first micro-display emits the radiation R1 in a first spectral range and the second micro-display emits the radiation R2 in a second spectral range disjoint from the first spectral range.

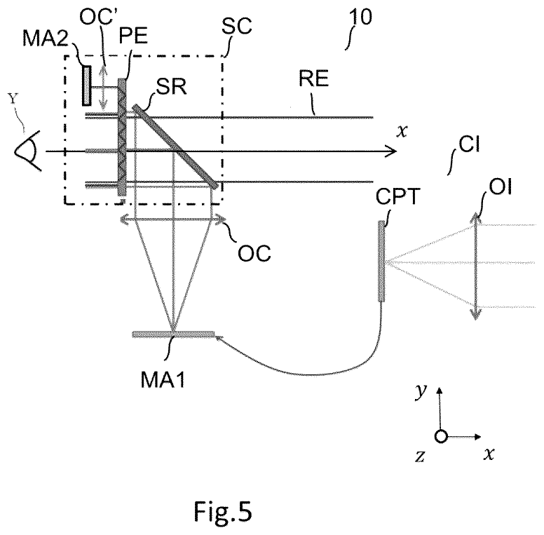

FIG. 5 is a schematic depiction of one embodiment of the scope 10 in which the optical combining device SC comprises the plane semi-reflective surface SR, an additional eyepiece OC′ and a pupil-expansion light guide PE.

The plane semi-reflective surface SR of the embodiment of FIG. 5 is identical to the one described in the embodiment of FIG. 4.

The additional eyepiece OC′ is arranged so as to form an image of the second micro-display at infinity.

The pupil-expansion light guide PE is arranged on the optical path of the rays coming from the second display and is designed to extend a pupil of the additional eyepiece OC′ in two directions of space by also participating in the superposition of the first and second image on the external landscape.

A pupil-expansion light guide PE is a component that is known per se, made of a transparent material and comprising plane and parallel faces. The light beams coming from the second micro-display MA2 and collimated by the additional eyepiece OC′ penetrate for example into the light guide via one of its lateral faces. Entry into the guide may take place using a prism, but also with a grating, which is then called an entrance grating. These beams propagate through the light guide by way of total reflections from plane and parallel faces. In order for the observer to be able to perceive an image, it is necessary to make it leave the guide. There are numerous optical solutions. By way of first example, the light guide PE comprises two parallel semi-reflective plates positioned at an angle between the parallel faces of the light guide PE, so as to extract some of the collimated beams. By way of second example, the light guide PE comprises an array of microstructures or microprisms or else a diffraction grating that carries out the same functions. These elements may be situated on one of the two faces of the light guide. They may also be situated inside the guide.

In the embodiment illustrated in FIG. 5, the observer Y looks directly at the landscape through the light guide PE. This is referred to as a see-through light guide PE.

Integrating the pupil-expansion light guide PE makes it possible to greatly reduce the space taken up along the axis x by the combiner element of the scope. Indeed, compared to a splitter plate inclined by 45° with respect to the axis x, the light guide PE extends primarily along a plane substantially perpendicular to the axis x. Its length (dimension along the axis x) is thus reduced to a minimum. The user is thus able to have a better understanding of their environment.

More preferably, according to one embodiment different from the one illustrated in FIG. 5, the plane semi-reflective surface SR is replaced by an additional pupil-expansion light guide designed to extend a pupil of the first eyepiece in two directions of space by superimposing the first and second image on the external landscape. This embodiment exhibits compactness that is further improved compared to the embodiment of FIG. 5.

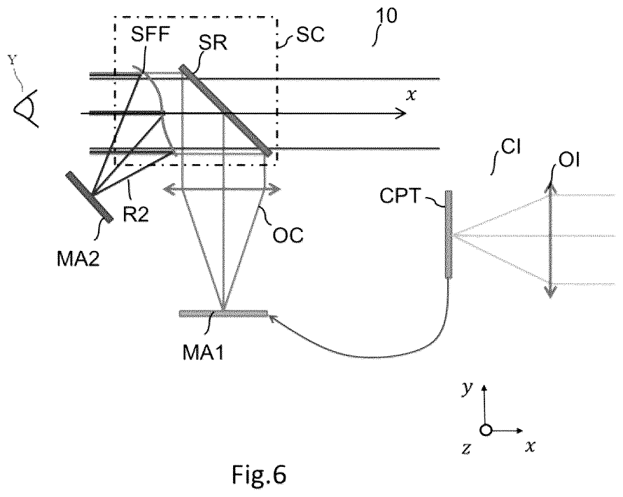

FIG. 6 is a schematic depiction of one embodiment of the scope 10 in which the optical combining device SC comprises the plane semi-reflective surface SR (or the surface SR comprising a dichroic treatment) and a plate SFF comprising two freeform or aspherical concave surfaces. A freeform surface is understood to mean a surface that does not exhibit rotational symmetry. It is the shape of these surfaces that directly creates the optical power for returning the image of the second micro-display at infinity to the eye of the user. It is necessary to use a plate SSF with two freeform or aspherical surfaces in order not to disturb the vision of the external landscape through this plate SFF.

The plane semi-reflective surface SR (or the surface SR comprising a dichroic treatment) of the embodiment of FIG. 6 is identical to the one described in the embodiment of FIGS. 4 and 5.

The freeform or aspherical concave surface SFF is inclined with respect to the sighting or observation axis x and is arranged on the optical path of the rays coming from the second display so as to form the image at infinity of the second micro-display MA2. Compared to the embodiments mentioned above, the concave surface SFF has more degrees of freedom for optimizing the profile of the surface, thus making it possible to achieve better collimation.

In all of its embodiments, the sighting scope according to the invention may comprise additional modular optical systems for modifying the perception of the external landscape. It is thus possible to position, downstream of the optical combiner, magnifying afocal optics with a magnification of 3, for example. In the same way, it is possible to position, upstream of the optical combining device SC, a light-intensifying optical module that is invariant in terms of magnification and axis deviation. The user thus perceives both an intensified image and a thermal image of the external landscape.

1. A sighting or observation scope having a sighting or observation axis x and comprising, in a mechanical structure (SM):
a camera (CI),
a first video micro-display (MA1) displaying an image of the external landscape acquired by the camera, as a first object,
an eyepiece (OC) associated with the first video micro-display and forming a first image of the first object at infinity,
a second video micro-display (MA2) displaying a second object, and
an optical combining device (SC) arranged optically downstream of the eyepiece and designed to form an image at infinity of the second object, as a second image, and to superimpose the first and second image on the external landscape.

2. The scope as claimed in claim 1, wherein the second micro-display is a micro-display with low power consumption compared to the first micro-display.

3. The scope as claimed in claim 2, wherein the second micro-display has a refresh rate less than or equal to 2 Hz, the first micro-display having a refresh rate greater than or equal to 20 Hz.

4. The scope as claimed in claim 2, comprising a battery supplying power to the camera, the first and second video micro-display and a processor, said processor being configured to make the battery operate in two distinct modes comprising:
in a first mode, supplying power to the first video micro-display and not supplying power to the second video micro-display or supplying power to the first and second micro-display (MA1, MA2) when a capacity of the battery is greater than a predetermined limit or when the user chooses it, for example by pressing a control member (IC) offset on said mechanical structure,
in a second mode, supplying power to the second video micro-display and not supplying power to the first video micro-display when a capacity of the battery is less than the predetermined limit, or when the processor detects malfunctioning of the first display, or when the user chooses it, for example by pressing a control member (IC) offset on said mechanical structure.

5. The scope as claimed in claim 4, wherein the predetermined limit corresponds to an autonomy of the battery in the first operating mode of less than 1 hour of use.

6. The scope as claimed in claim 1, wherein the first micro-display emits radiation in a first spectral range and the second micro-display emits radiation in a second spectral range disjoint from the first spectral range or the first and second micro-displays (MA1, MA2) emit radiation in one and the same spectral range but having cross-polarization.

7. The scope as claimed in claim 1, claims, wherein the optical combining device comprises:
a plane semi-reflective surface (SR) inclined by approximately 45 degrees to the sighting or observation axis x or a surface (SR) comprising a dichroic treatment designed to reflect a spectral range of the radiation emitted by the first micro-display, said plane semi-reflective surface (SR) being designed to perform said superposition of the first and second image on the external landscape,
a holographic or diffractive element or a metasurface (EH) arranged on the optical path of the rays coming from the second display and designed to form said second image.

8. The scope as claimed in claim 7, wherein the first micro-display emits radiation in a first spectral range and the second micro-display emits radiation in a second spectral range disjoint from the first spectral range or the first and second micro-displays (MA1, MA2) emit radiation in one and the same spectral range but having cross-polarization, and
wherein said holographic or diffractive element or said metasurface (EH) has a holographic treatment and/or a structure specifically designed to form an image from rays having a wavelength in the second spectral range and designed to transmit the first spectral range.

9. The scope as claimed in claim 7, wherein said holographic or diffractive element or said metasurface (EH) is deposited on or added to the plane semi-reflective surface (SR).

10. The scope as claimed in claim 7, wherein said holographic or diffractive element or said metasurface (EHD) is separate from the plane semi-reflective surface (SR).

11. The scope as claimed in claim 10, wherein said holographic or diffractive element or said metasurface (EH) is arranged so as to be substantially perpendicular to the sighting or observation axis x.

12. The scope as claimed in claim 10, wherein said holographic or diffractive element or said metasurface (EH) comprises a concave surface inclined with respect to the sighting or observation axis x.

13. The scope as claimed in claim 1, wherein the optical combining device comprises:
a plane semi-reflective surface (SR) inclined by approximately 45 degrees to the sighting or observation axis x, said plane semi-reflective surface (SR) being designed to perform said superposition of the first and second image on the external landscape
a freeform or aspherical concave surface (SFF) inclined with respect to the sighting or observation axis x and arranged on the optical path of the rays coming from the second display so as to form said second image.

14. The scope as claimed in claim 1, wherein the optical combining device comprises:
a plane semi-reflective surface (SR) inclined by approximately 45 degrees to the sighting or observation axis x, said plane semi-reflective surface (SR) being designed to perform said superposition of the first and second image on the external landscape
an additional eyepiece (OC′) designed to form the second image, a pupil-expansion light guide (PE) arranged on the optical path of the rays coming from the second display and designed to extend a pupil of the additional eyepiece (OC′) in two directions of space by also participating in said superposition of the first and second image on the external landscape.
